(19) United States
(12) Patent Application Publication
(10) Pub. No.: US 2017/0266077 A1
(43) Pub. Date: Sep. 21, 2017

(54) ROBOTIC MASSAGE MACHINE AND METHOD OF USE

(71) Applicant: Christian Campbell Mackin, Aliso Viejo, CA (US)

(72) Inventor: Christian Campbell Mackin, Aliso Viejo, CA (US)

(21) Appl. No.: 15/465,456

(22) Filed: Mar. 21, 2017

Related U.S. Application Data
(60) Provisional application No. 62/311,065, filed on Mar. 21, 2016.

(51) Int. Cl. A61H 15/00; A61H 37/00

(52) U.S. Cl. CPC A61H 15/0078; A61H 37/00; A61H 2201/5007; A61H 2201/5058; A61H 2201/5061; A61H 2201/5071

(57) ABSTRACT

A robotic massage machine that includes at least one movable robotic arm having a first end effector, a processor that controls the movable robotic arm, a memory, a first body form having at least a first anatomical calibration point, a preprogrammed initial massage path based on the first body form, and a second body form having at least a first anatomical calibration point located in an analogous anatomical location as the first anatomical calibration point of the first body form. The processor is programmed to morph the initial massage path to calculate a calibrated massage path based on the second body form.

This application claims the benefit of U.S. Provisional Application No. 62/311,065, filed Mar. 21, 2016, the entirety of which is incorporated by reference herein.

### FIELD OF THE INVENTION

The present invention pertains generally to robotic massage machines, and more particularly to a programmable massage machine having routines which control both the motion of end effectors and the localized ambient environment. The massage routines can also be shared via social network sharing.

### BACKGROUND OF THE INVENTION

Conventional massage machines, such as massage chairs, are typically pre-programmed in the factory to perform a finite number of routines. These programming routines typically control the rate of motion of end effectors. In robotics, an end effector is the device at the end of a robotic arm, designed to interact with the environment. The exact nature of this device depends on the application of the robot. In the case of massage robotics, the end effector is the tool that touches a body surface to effectuate tissue manipulation. The end effector can be of almost any form, but most commonly are in the form of rollers for robotic massage machines. A roller end effector enables easy movement over a body surface contour. Other forms often used for robotic massage machines are blunt finger like forms and other blunt shapes they may also include a vibrating and/or heating element. In the strict definition, which originates from serial robotic manipulators, the end effector means the last link (or end) of the robot. At this endpoint the tools are attached. In a wider sense, an end effector can be seen as the part of a robot that interacts with the work environment. This does not refer to the wheels of a mobile robot or the feet of a humanoid robot which are also not end effectors; they are part of the robot's mobility.

In the case of massage chair machines, the end effectors are typically constrained to move within mechanical guiding mechanisms such as rails and pivots. The end effectors of these machines are limited to motions based on the mechanical structure built in the factory. The end effectors are also limited to forms such as rollers, balls and blunt ends built in the factory and installed in the machine. The routines are limited to those that are pre-programmed in the factory. Users of these massage machines often purchase them to reduce deep tissue pain based on a relatively short trial and positive experience of pain relief. Later, the limitations in variability of end effectors, the limited motions of end effectors and the increasing monotony of a finite set of routines become less effective for the same user's pain relief much in the same way a single pain reliving drug becomes less effective over time for chronic pain.

The limitations of massage chair machines, as discussed above, are well known in the industry. There are research and development projects at universities and companies that are utilizing soft compliant multi-axis robotic arms to control the motion of various forms of end effectors with the design intent to bio-mimic the massage motions of a masseur. By increasing the degrees of freedom for manipulating end effectors, these machines can overcome motion limitations of massage chair machines; however, the expertise required for programming a routine for these machines is a limitation for a typical end user. While the multi-axis robotic arm(s) overcome the motion limitation of the typical massage chair, the end user programming limitation requires factory pre-programming of routines similar to the massage chair. Moreover, the massage chair machines typically only address simple therapeutic modalities and do not included other therapeutic modalities such as electro-therapy, laser light therapy and focused hot/cold therapy. Addressing primarily the touch sensory body system of the user massage chairs do not address visual, sound and olfactory sensory body systems.

See, for example, U.S. Pat. Nos. 5,083,552, 5,233,973, 6,585,668, 6,734,851, 7,190,379, 6,594,844, 6,809,490, 7,430,455, 5,886,710, 5,408,272, 4,758,892, 5,872,564 and 8,612,884, U.S. Patent Publication Nos. 2002/0089500, 2003/0098872, 2004/0056871, 2004/0085443, and 2005/0100243 and European Patent Office Publication No. EP0828232A2, the entireties of which are incorporated herein by reference.

### SUMMARY OF THE PREFERRED EMBODIMENTS

In accordance with a first aspect of the present invention there is provided a robotic massage machine that includes at least one movable robotic arm having a first end effector, a processor that controls the movable robotic arm, a memory, a first body form having at least a first anatomical calibration point, a preprogrammed initial massage path based on the first body form, and a second body form having at least a first anatomical calibration point located in an analogous anatomical location as the first anatomical calibration point of the first body form. The processor is programmed to morph the initial massage path to calculate a calibrated massage path based on the second body form. In a preferred embodiment, the processor is programmed to move the robotic arm such that the end effector follows the calibrated massage path. In a preferred embodiment, the processor is programmed to move the robotic arm such that the end effector moves within an area bounded by the calibrated massage path.

In a preferred embodiment, the processor is programmed to maintain the end effector at an orientation that is generally normal to the subject. Preferably, the processor is programmed to cause the robotic arm to press the end effector against the subject at a generally constant pressure. In a preferred embodiment, the robotic arm includes a sensor that senses the pressure applied to the subject. In another embodiment, the robotic arm includes a series elastic motor.

In a preferred embodiment, the first body form includes a plurality or set of anatomical calibration points and the second body form includes a plurality or set of analogous anatomical calibration points. Preferably, the robotic massage machine includes a plurality of movable robotic arms that are controlled by the processor and that includes at least one module that is pivotable about an axis.

In accordance with another aspect of the present invention there is provided a method of controlling a robotic massage machine having a processor, a memory, and at least one movable robotic arm that includes the steps of providing a preprogrammed initial massage path on a first body form, and morphing the initial massage path on a second body form to calculate a calibrated massage path. In a preferred embodiment, the first body form has at least a first anatomical calibration point, and the second body form has at least a first anatomical calibration point located in an analogous anatomical location to the first anatomical calibration point of the first body form. In a preferred embodiment, the method includes determining the first anatomical calibration point of the second body form, and inputting the data associated with the first anatomical calibration point of the second body form.

In a preferred embodiment, the present invention is directed to a robotic massage machine (also referred to herein generally as a robot) disposed in an environmentally controlled enclosure and connected in a social network architecture. In another embodiment, the machine can be disposed in a non-environmentally controlled enclosure. In another embodiment, the machine is not connected to social network architecture, but is a standalone or closed-circuit machine. In an embodiment with an environmentally controlled enclosure, enclosure creates a private space that is temperature controlled as well as insulated from outside sound and light. Other environmental controls such as humidity can also be controlled. The massage machine within the enclosure consists of one or more multi-axis robotic arms with interchangeable end effectors. In another embodiment the and effectors are not interchangeable. The arm(s) are mounted to a robotic table that consists of one or more and preferably several padded modules. Each module can rotate with various degrees of freedom to accommodate different user orientations as well as to provide robotic therapeutic mobility actions. The robotic arms can include end effectors that can be changed. For example, the robotic arm can be outfitted with an electric pulse stimulator and placed in contact with the skin to cause muscle contractions for therapeutic purposes. A laser light can be attached as an end effector and used for hair removal and for other light therapy purposes. Because the robot can remember precisely where and for how long a particular therapeutic modality has been applied, it makes it more effective for implementing therapies that require repeated application over long periods of time and multiple visits. The robotic system may be programmed by a user through an intuitive teaching function by physically moving the components as desired and recording the path, speed and pressure. It may also be programmed through a remote web interface to perform massage and physical therapy routines. The programmed routines may be shared between medical professionals and patients or between friends within a social network. Programmed routines are easily calibrated to accommodate different anatomical forms between users. Program data and feedback sensory data are stored for each massage and therapy event within a database and can be accessed by medical professionals to evaluate therapeutic progress. Doctors or other medical professionals can also prescribe and send massage routines to user accounts. Users can then access the prescribed routines at participating facilities.

Other embodiments, in addition to the embodiments enumerated herein, will become apparent from the following detailed description, taken in conjunction with the accompanying drawings, which illustrate, by way of example, the principles of the robotic massage machine and method of use.

### BRIEF DESCRIPTION OF THE DRAWINGS

FIG. 1 is a cutaway perspective view of a massage machine inside a privacy pod enclosure in accordance with a preferred embodiment of the present invention;

FIG. 2 is a top view of a massage machine inside a privacy pod room of the present invention;

FIG. 3 is a perspective view of a massage machine that can be used with the present invention;

FIG. 4 is a top view of a massage machine that can be used with the present invention;

FIG. 5 is a side view of a massage machine that can be used with the present invention;

FIG. 6. is a side view of a massage machine that can be used with the present invention;

FIG. 7 is a top view of a massage machine that can be used with the present invention;

FIG. 8 is a top view of two massage machines showing two embodiments of the outer range of motion of the robotic arms;

FIG. 9 is a perspective view of a massage machine showing the robotic arms and their associated joints;

FIG. 10 is a perspective view of the robotic massage machine in the mobile transport configuration;

FIG. 11 shows different views of the human body and exemplary calibration points thereon;

FIG. 12a shows side-by-side views of a human body with one showing an initial path and the other showing a calibrated bath;

FIG. 12b shows side-by-side views of a human body one showing an initial massage area and the other showing a calibrated massage area;

FIG. 13 shows an area of a body with an end effector thereon;

FIG. 14 shows a network diagram;

FIG. 15 shows an exemplary interface touch tablet;

FIG. 16 is a flow chart showing authentication;

FIG. 17 is a flow chart showing an operation sequence;

FIG. 18 is a schematic showing an example of how an initial massage path is modified to a calibrated massage path; and

FIG. 19 shows an exemplary programmed massage routine composition on a timeline.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “upper,” “lower,” “side,” “short,” “long,” “up,” “down,” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including mobile devices, terminals, databases and external services. The server can comprise a computing device capable of receiving input commands, processing data, and outputting the results for the user. Preferably, the server consists of RAM (memory), hard disk or Solid State Drive (SSD), network, central processing unit (CPU). It will be understood and appreciated by those of skill in the art that the server could be replaced with, or augmented by, any number of other computer device types or processing units, including but not limited to a desktop computer, laptop computer, mobile or tablet device, terminal, embedded system or the like. Similarly, the hard disk could be replaced with any number of computer storage devices, including flash drives, removable media storage devices (CDs, DVDs, etc.), or the like.

The network can consist of any network type, including but not limited to a Cloud network, local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk or SSD, Cloud, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, the mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, G-Code, Robot Operating System (ROS) or the like, or macros using Excel or other similar or related applications with various algorithms being implemented with any combination of data structures, objects, processes, routines or other programming elements.

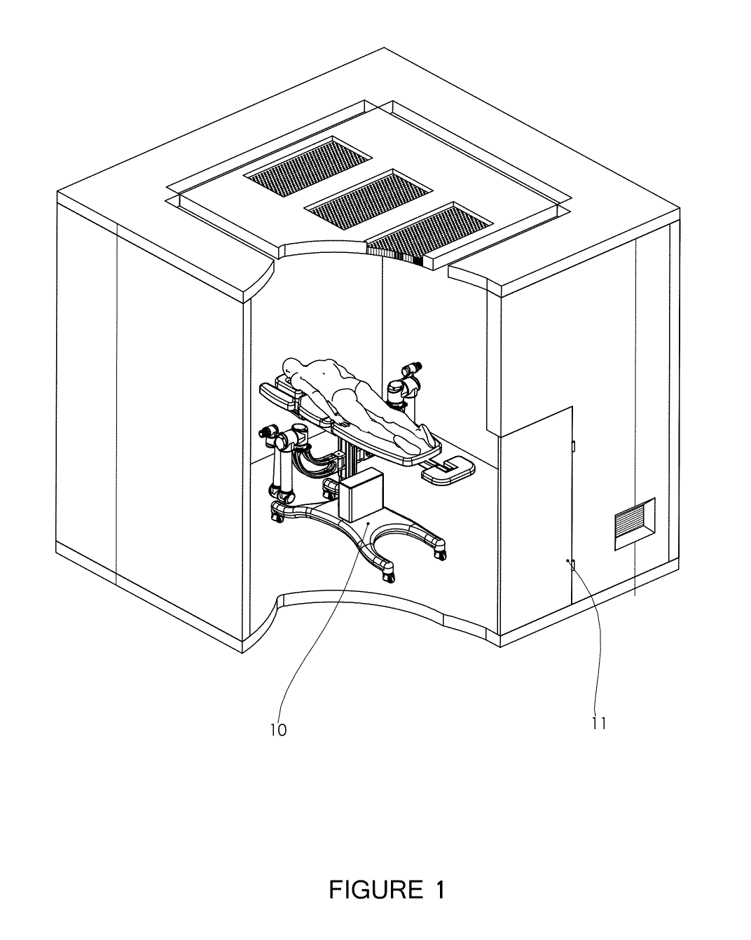

Referring now to the invention in more detail, in FIG. 1 there is shown a simplified networked single unit multi-axis robotic machine 10 inside a pod enclosure 11 with a cutout for internal clarity.

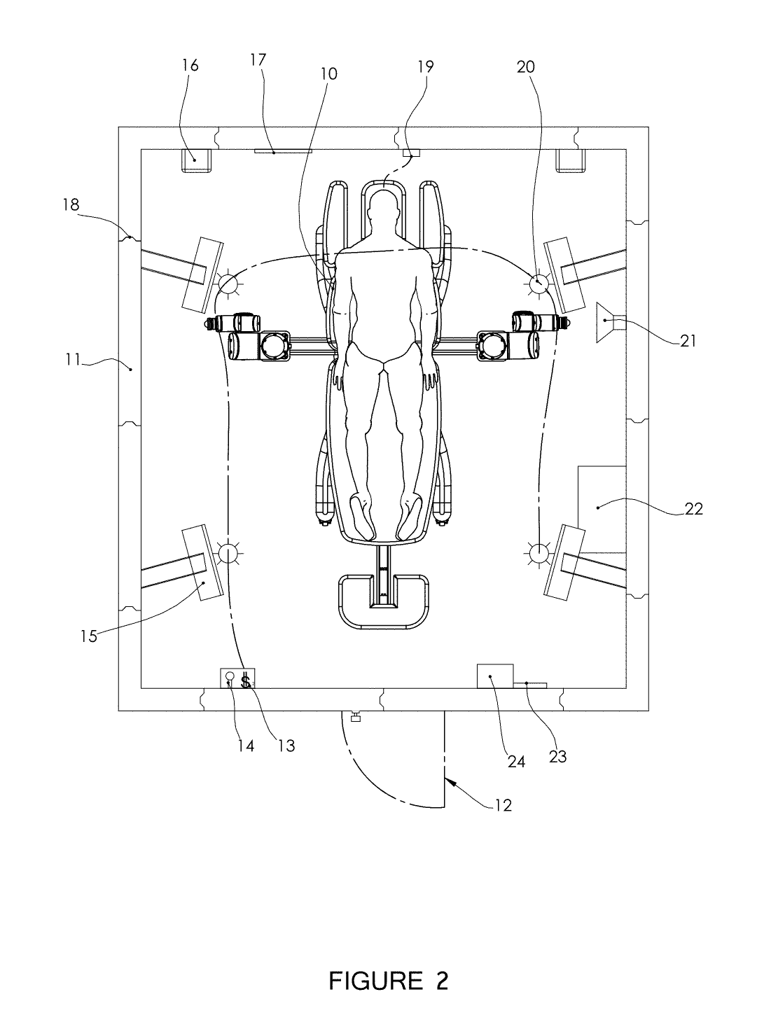

In further detail, referring to FIG. 2, there is shown a top view of a privacy room pod 11, which is generally constructed of interlocking modular walls, floor and ceiling panels 18. In further detail referring to items inside the pod 11 are shown infrared heating panels 15, convenience outlet 14, light switch 13, wireless environmental controls 24 (these can also be wired), supply air vent 17, return air vent 23, shelf 22, speakers 16, lights 20, aroma emitter 21, network jack 19 and door 12. In the middle of the room is shown a robotic machine 10.

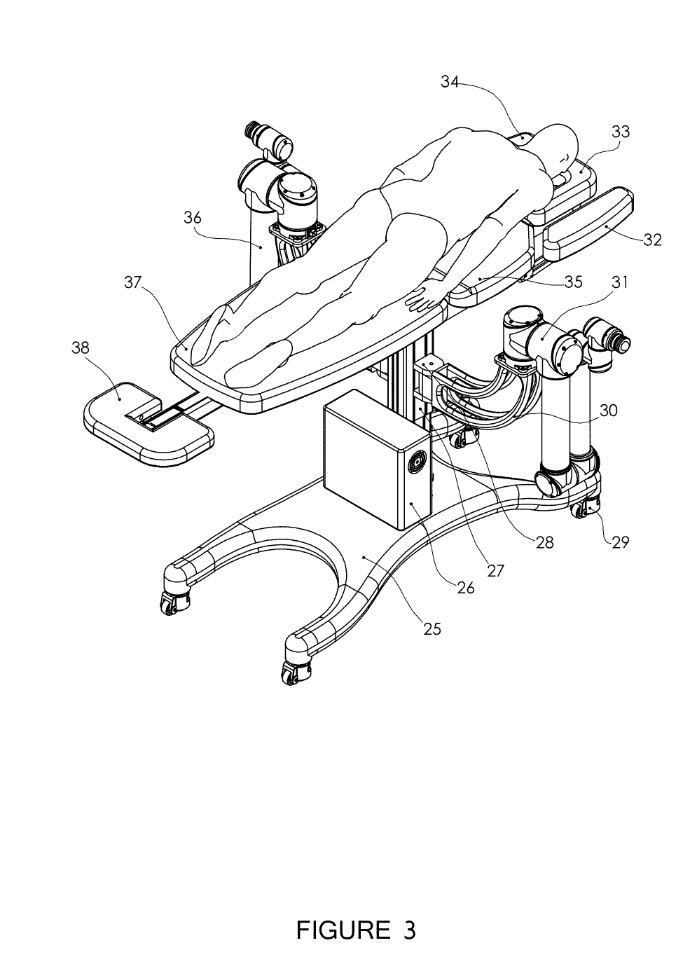

In further detail, referring to FIG. 3 there is shown a robotic machine 10 having multiple padded modules, namely: a foot module 38, a leg module 37, thoracic module 35, a head module 33, a first or left arm module 34 and a second or right arm module 32. Each of the modules are connected at articulating joints that provide one or more degrees of freedom for motion. The jointed modules shall be configurable to accommodate the ergonomic articulations of human anatomy. Each module may be held in static positions or manually as well as robotically moved through available degrees of freedom.

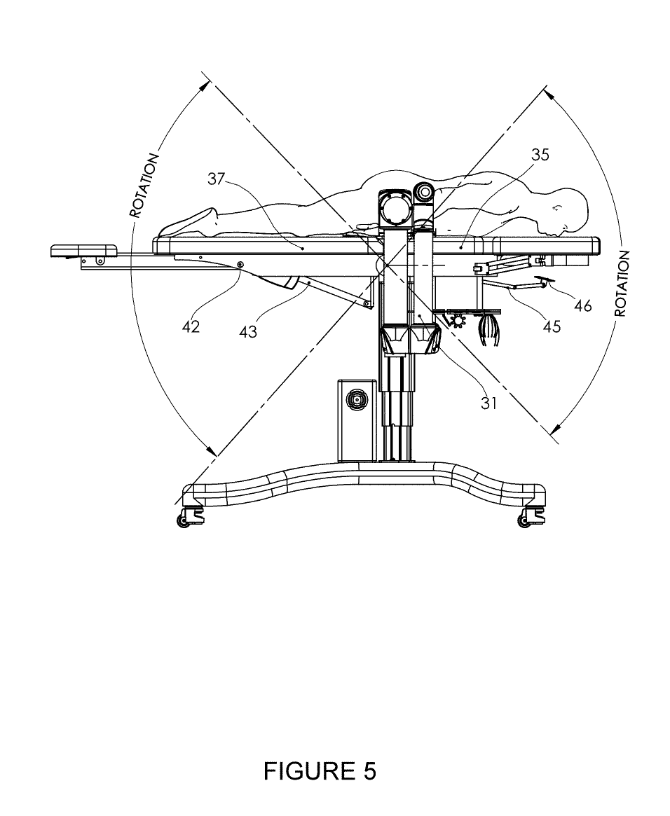

Referring further to FIG. 3 there is shown two multi-axis robotic arms 31, 36 that are mounted on two risers 30, respectively. The risers 30 are connected through a vertical axis pivot joint 28 to a vertical telescopic post 27. The post 27 is mounted to the base frame 25. The base frame 25 is shown with four rollers with integrated lock out pads 29. In a different embodiment, a base frame 25 and/or rollers 29 may not be required. Still referring to FIG. 3 there is shown the foot pad 38, leg pad 37, thoracic pad 35, Head pad 33, arm pads 32,34 and controller 26 with integrated microphone to receive voice commands from the user in addition to touch commands from the user interface 46, as shown in FIG. 5.

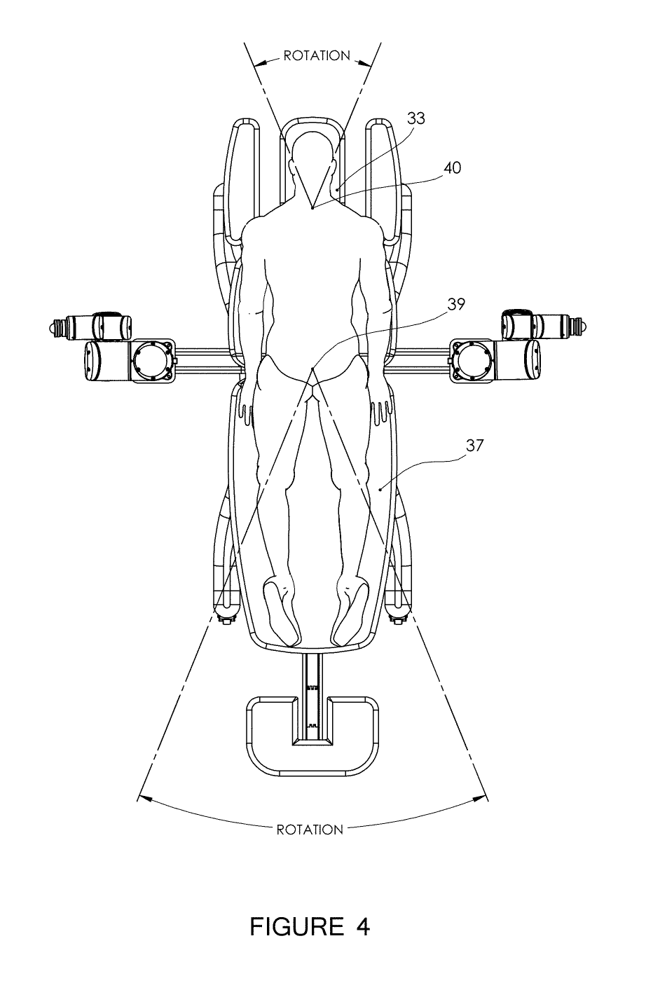

In further detail, referring to FIG. 4 there is shown a top view of the robotic machine 10 with horizontal rotation freedom (or swivel/pivot freedom) for the leg module 37 pivoting at joint 39. Also shown in FIG. 4 is horizontal rotation freedom (or swivel/pivot freedom) for the head module 33 pivoting at joint 40. Any angle of horizontal rotation is within the scope of the present invention. However, in a preferred embodiment, the leg and head modules, 37, 33 (or any other module) can pivot anywhere between 1° and 89° (in both directions) with respect to a vertical plane that bifurcates the machine (or a longitudinal axis of the machine extending parallel to the ground).

In further detail, referring to FIG. 5, there is shown the vertical rotation freedom for the leg pad 37 and the thoracic pad 35. An electro mechanical actuator 43 is shown as the drive mechanism to rotate the leg pad 37 and support frame 42. Each pad may be driven by a mechanical actuator or in a different embodiment they can be moved manually. Any angle of vertical rotation is within the scope of the present invention. However, in a preferred embodiment, the leg and thoracic modules or pads, 37, 35 (or any other module) can pivot anywhere between 1° and 89° (in both directions) with respect to a horizontal plane that bifurcates the machine (or a longitudinal axis of the machine extending parallel to the ground). Still referring to FIG. 5 is shown the user interface touch tablet 46 held on an armature 45.

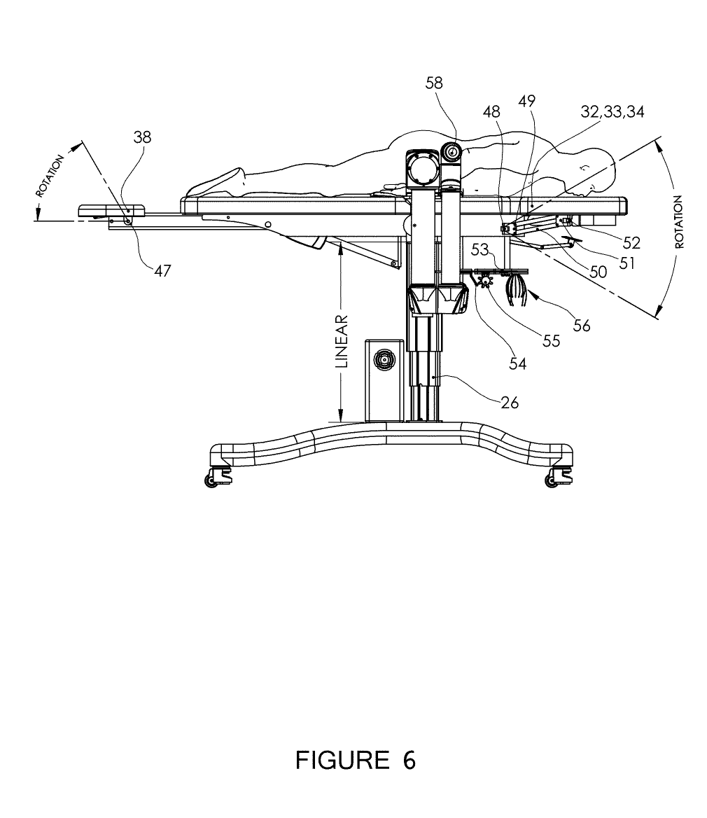

In further detail, referring to FIG. 6 shows the foot pad 38 that rotates around pivot point 47. Also in FIG. 6 is shown the arm pads 32, 34 and head pad 33 that rotate round pivots and linkages 48, 49, 50, 51, 52. Any angle of rotation is within the scope of the present invention. However, in a preferred embodiment, the foot module 38, arm modules 32, 34 and head module 33 (or any other module) can pivot anywhere between 1° and 89° (in both directions) with respect to a horizontal plane that bifurcates the machine (or a longitudinal axis of the machine extending parallel to the ground). Still referring to FIG. 6, there is shown a variety of end effector massage elements, 54, 55, 56 that are supported by a rack 53. Each end effector utilizes a common mounting element to facilitate automatic interchangeability. Still referring to FIG. 6 there is shown a telescopic support leg 26 that allows the various modules supporting the patient (referred to herein collectively as the “table”) to be raised or lowered.

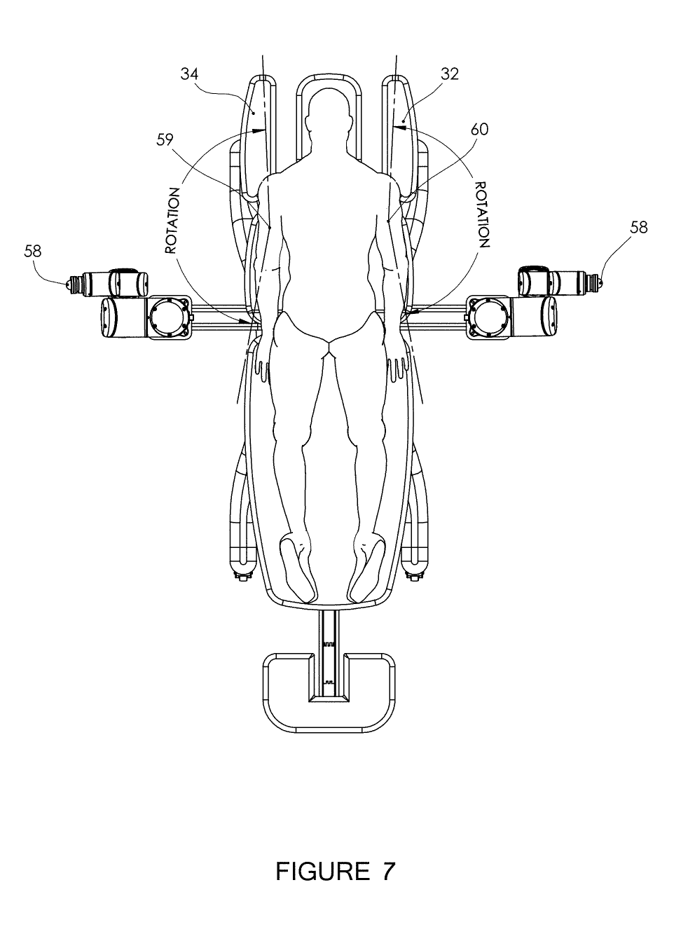

In further detail, referring to FIG. 7 shows the rotation scheme for the arm rests 32, 34 around pivot points 59 and 60. It will be appreciated that the arm rests 32, 34 can preferably pivot about 180° to accommodate a patient with their arms by their sides or over their head. Still referring to FIG. 7 are shown interchangeable rolling ball end effector massage elements 58.

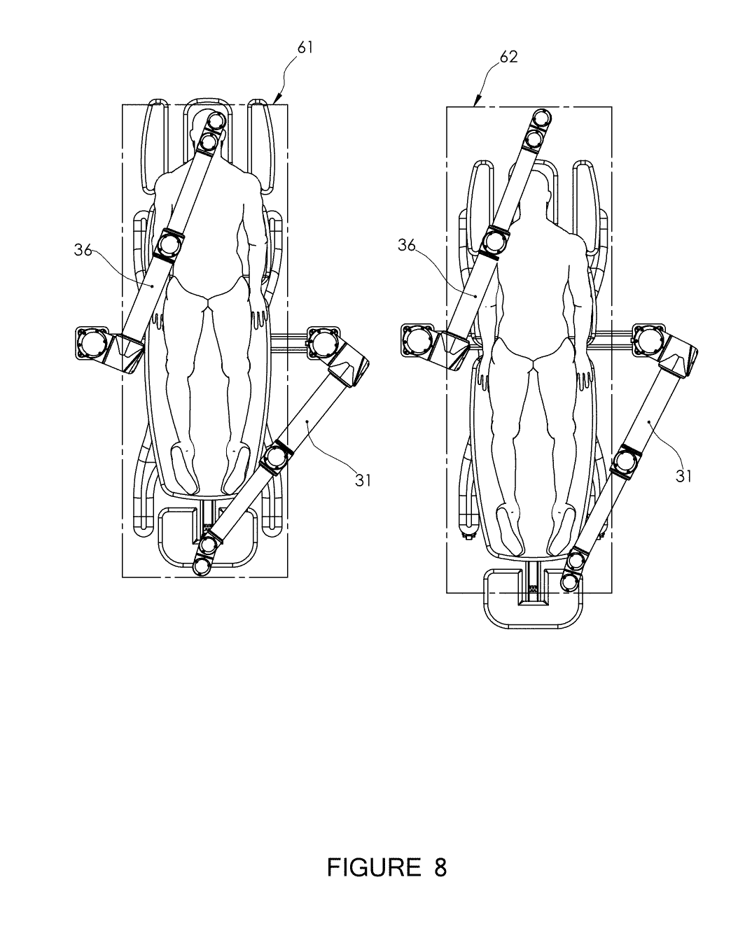

In further detail, referring to FIG. 8 is shown the robotic arms 31, 36 illustrating the standard range of motion from head to toe as outlined in the dotted line 61. Still referring to FIG. 8 in a preferred embodiment, the machine 10 includes a linear sliding mechanism that allows the whole table (or specific modules thereof) to translate (or mood generally horizontally) toward the head or toe directions to increase the effective motion envelope for the arms 31, 36 as needed. In a preferred embodiment, the linear sliding mechanism is positioned below the table pads. This expanded range is illustrated with dotted line 62.

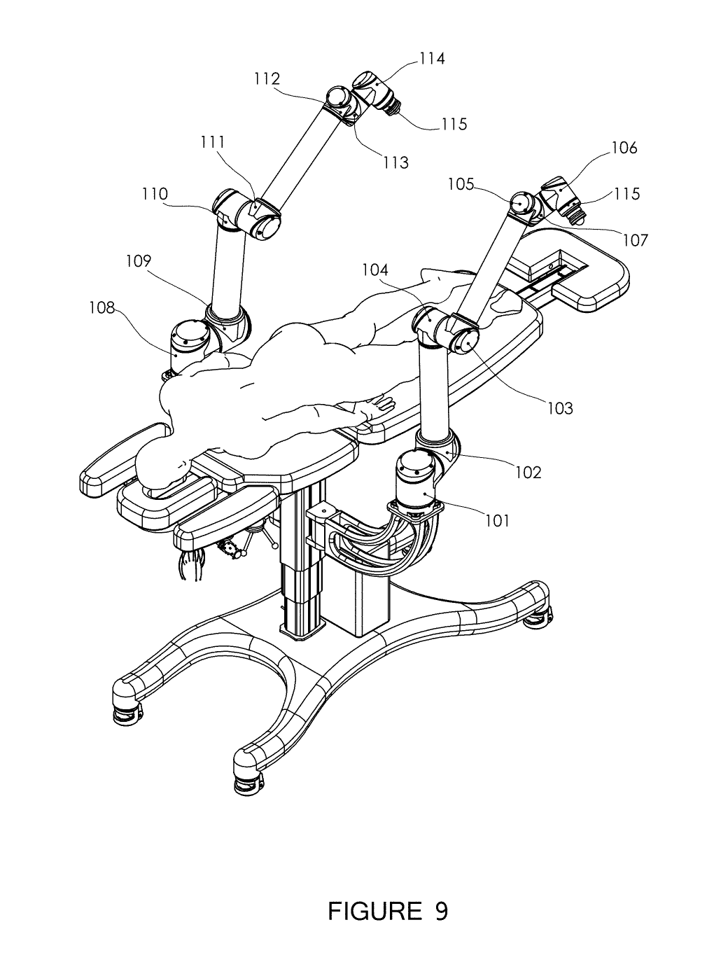

In further detail, referring to FIG. 9 are shown the robotic arms joints 101, 102, 103, 104, 105, 106, 107, 108, 109, 110, 111, 112, 113, 114, 115. Each joint represents a single axis and degree of freedom.

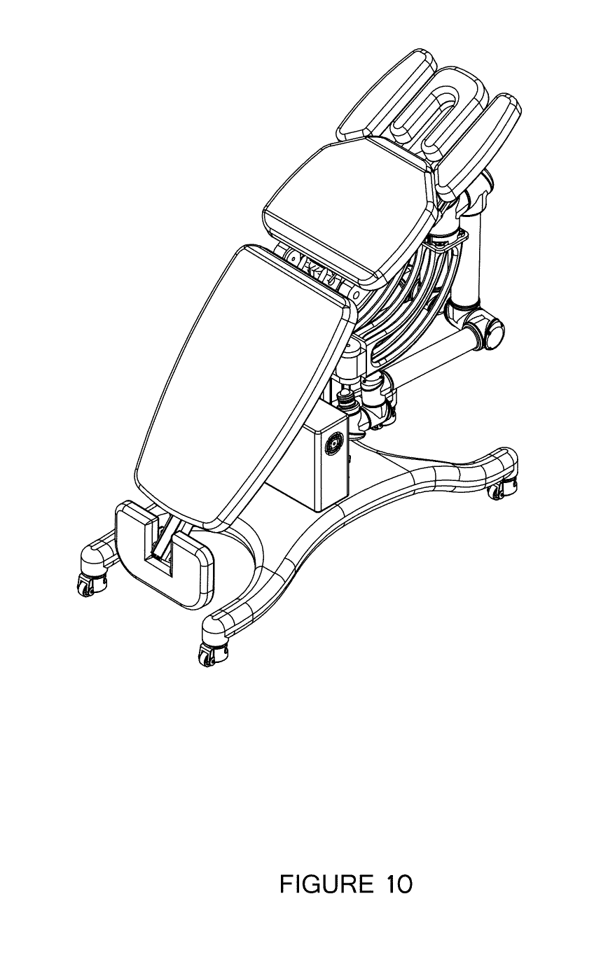

In a preferred embodiment, the machine is movable between a use configuration and a transport configuration. FIG. 10 shows the machine in the transport configuration with the table raised and the arms folded inward the produce a narrow profile to enable the machine to roll on the casters and fit through a standard door width.

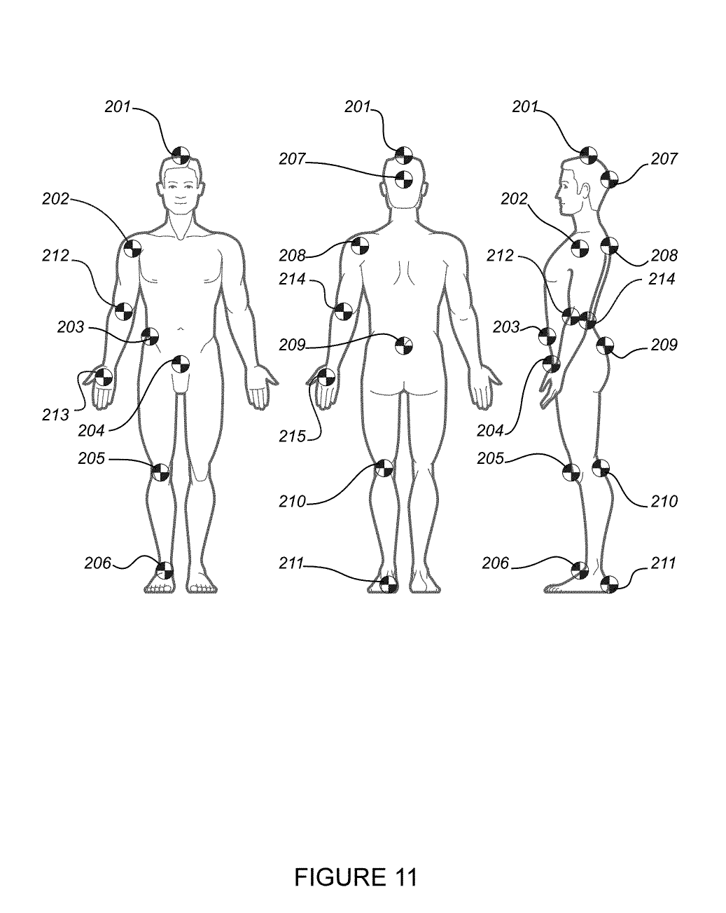

In further detail, referring to FIG. 11 are enumerated anatomical points (201-215) that are to be used for calibrating the programmed paths to follow by the robot end effectors (referred to herein as anatomical calibration points). The number of points shown is for illustration purposes only. In this illustration an assumption of symmetry is made. It is contemplated that many more anatomical calibration points may be required to adequately map the variations of human form as needed to adapt end effect paths within nodal boundaries. The path the end effector follows is similar to the path followed by a CNC milling machine as it cuts out the shape of a pre-programmed part. In this case the part is the human and the end effector path is pre-programmed for a given human. In order for a pre-programmed or initial path (also referred to herein as the “initial massage path”) to be adapted for use on differing body shapes and sizes, anatomical calibration points are used as boundary nodes to mathematically stretch or squeeze the general area of a pre-programmed path between bounding nodal points. Each user therefore calibrates the machine to their individual body, as described below. A mathematical adaptation of the end effector path x,y,z coordinates are matched to body shape based on differential calibration (referred to herein as a “calibrated path” or “calibrated massage path”). It will be appreciated by those of ordinary skill in the art that the calibrated path is morphed, warped or skewed from the original path. In other words the aspect ratio of the vector graphic is adjusted. For a similar teaching see U.S. Pat. No. 7,312,805 (referred to herein as the “'805 patent”), the entirety of which is incorporated herein by reference.

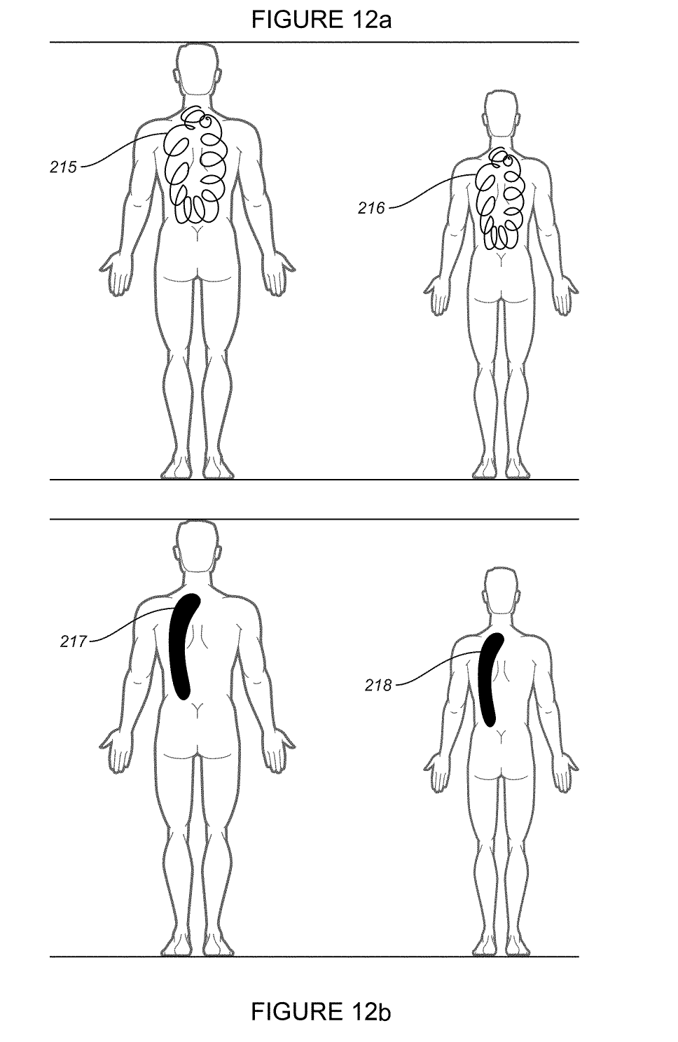

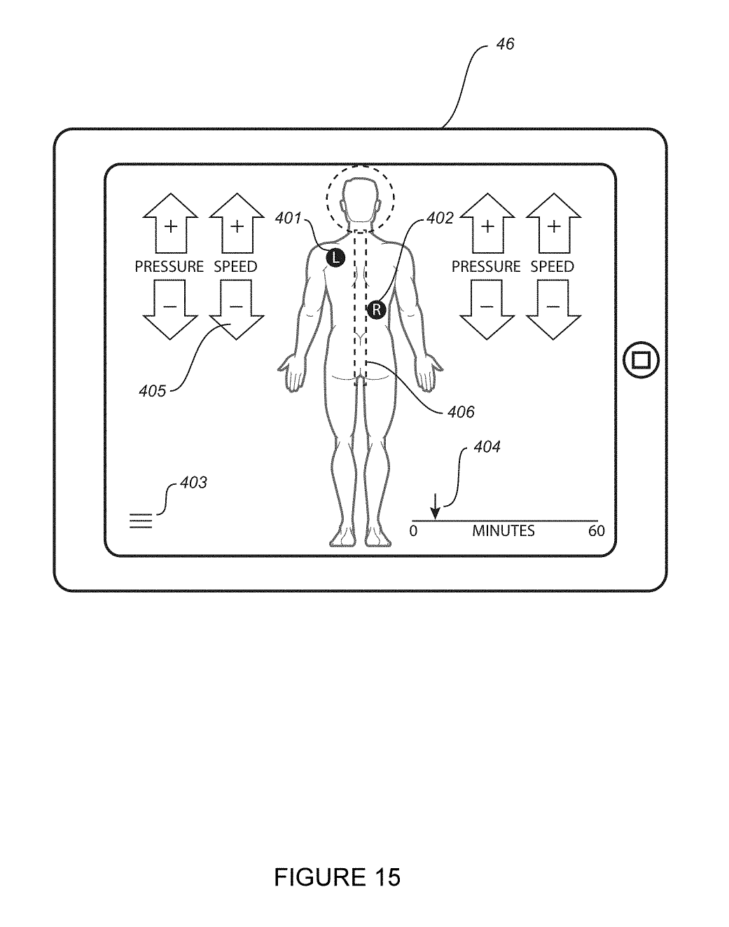

By way of example, two human forms are shown in FIGS. 12a-12b that are of different size. An end effector initial path 215 is shown on the larger body form (User A) and a calibrated path 216 shown on the smaller body form (User B). The robot can be programmed with a discrete end effector initial path and that path can be calibrated or changed (i.e., made larger or smaller, as shown in FIGS. 12a and 12b) to accommodate different body forms. Similarly, the robot can be programmed to perform random motions within a given area or volume 217 (referred to herein as an “initial massage area”) on one body form (User A) and do the same in a calibrated area or volume 218 on another body form (User B) (referred to herein as a “calibrated massage area”). In one embodiment, the initial path is overlaid on the body form of User B and an anchor point (e.g., one of the anatomical calibration points shown in FIG. 11) is provided (e.g., at a point where the X/Y coordinates are 0). Then the shift is determined between User A and User B based on the difference in X/Y coordinates and the shift is applied to create the calibrated massage path. In other words, the initial massage path is then stretched or skewed relative to the anchor point to cover the desired area of User B (made smaller in the example shown in FIGS. 12a and 12b). This can be performed by automatically by the system (e.g., programmed into the controller) or it can be done by a user using the touchpad or the like. In other words, the user can overlay the initial path on the body form of the touchpad (see FIG. 15) and then drag and/or pull/push the path to the desired size to create the calibrated path.

In a preferred embodiment, in order to initially calibrate the robot to each individual user, common or analogous anatomical points on a user's body such as the center line of the spine, shoulder blade or top of the head are recorded into robot memory by physically moving the robot end effector to each anatomical calibration point by issuing a store physically or voice command. The anatomical calibration points can also be established on a computerized body form of a certain size (e.g., a 5′4″ 130 lb female). Once established, common anatomical calibration points on the initial or first user body form and the second user body form representing the same anatomical position on each body form or user are used to calculate the vector difference of anatomical calibration points between users. This calculated vector may then be applied along the tool path using best-fit interpolation methods (see, e.g., the '805 patent).

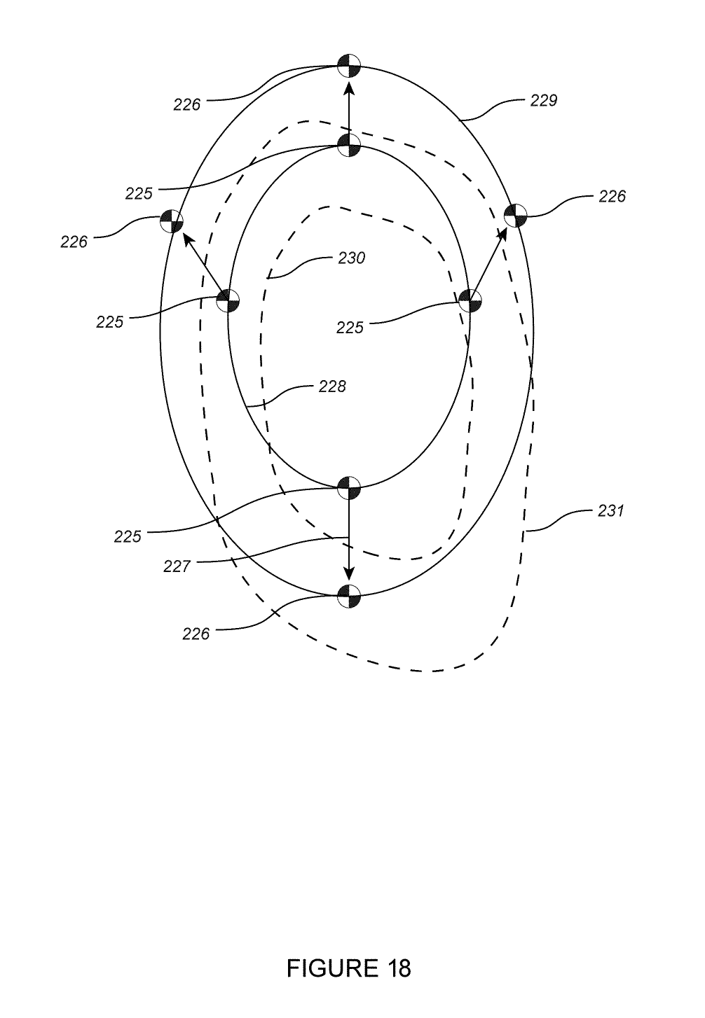

An exemplary embodiment of the calibration described above is shown in FIG. 18. An example is shown where the tool or end effector path 228, 229 passes directly through the anatomical calibration points and everything is symmetrical. This allows simple linear interpolation. In this embodiment, 228 represents the initial massage path from the first body form (or first user), which included four anatomical calibration points 225. The second body form (or second user) includes four respective anatomical calibration points 226 that are located at the same related anatomical points as the four first body anatomical calibration points 225. The initial massage path is then modified, morphed or adjusted (using calculated vectors 227) to the four second body anatomical calibration points 226 to form the calibrated massage path 229. Other points along the path are likewise adjusted in position based on the calibration point vector 227 adjustment and best fit interpolation methods. The dotted line initial massage path 230 shown in FIG. 18 is asymmetric with complex curves and does not pass directly through any calibration anchor points or anatomical calibration points. Modification of path 230 to calibrated massage path 231 requires asymmetric and non-linear interpolation to morph the initial path to the interpolated path. This process may be done mathematically, or the user can utilize the graphic user interface 46 to adjust the path much in the same way that a vector line is morphed within graphic design software such as Adobe Illustrator. Alternatively, the user can issue voice commands while the robot is executing the massage routine to nudge and adjust the path. For example, the user could say “stop,” “go back 10-seconds,” “a little bit to the left.” The robot will calculate an adjustment to the path based on stored user settings for quantifying what the statement “a little bit” means. In a preferred embodiment, there are also settings to establish the radius of influence for nudge commands so that the whole path is not transposed. Any adjustments to the routine are recorded and saved to the user's database of routines. The next time the routine is executed the robot will follow the adjusted path. It will be appreciated by those of ordinary skill in the art that the initial massage path can also be the outer boundary of the initial massage area. Therefore, in the example shown in FIG. 12B, the outer boundary of 217 is the initial massage path.

A simple example of providing the calibrated massage path is as follows. A user chooses or obtains an initial massage path that is circular with a 10 cm diameter and includes a first anatomical calibration located at the tip of the left shoulder blade (the first anatomical calibration point of the first body form). It will be understood that the first anatomical calibration point is the center point of the circle. The robotic arm will then position the end effector at the user's left shoulder blade (the first anatomical calibration point of the second body form) and follow the 10 cm diameter path. In other words, the only morphing of the initial massage path to the calibrated massage path was moving the center point of the massage path to the user's left shoulder blade.

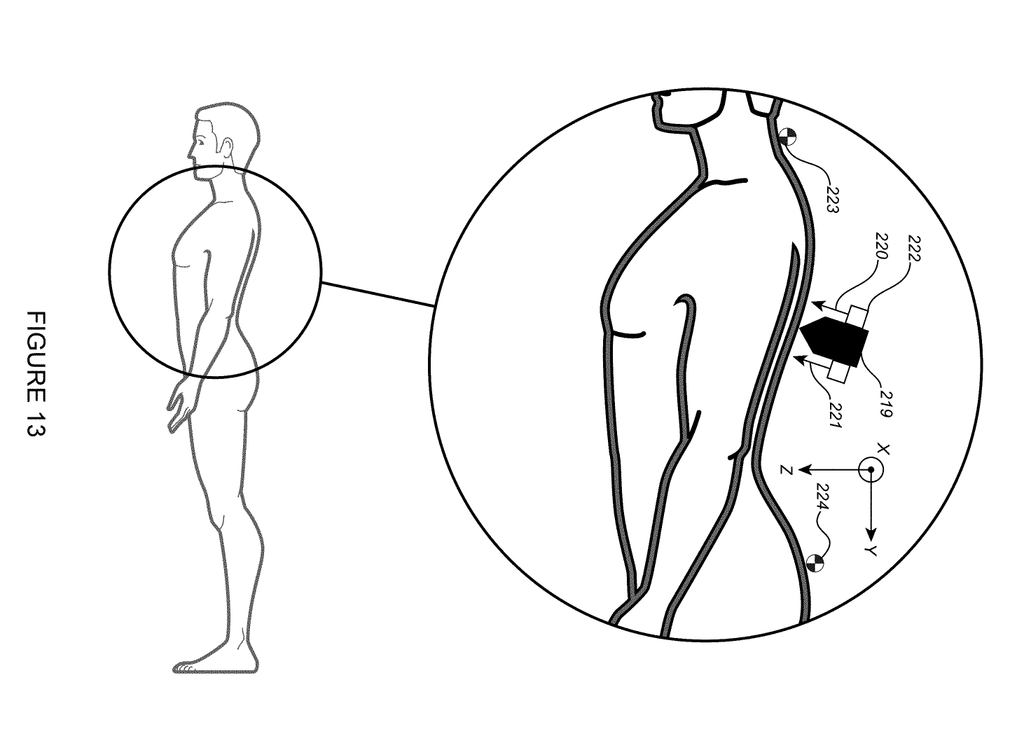

In FIG. 13 is shown further detail of how the robot end effector 219 (which can be any of the end effectors described herein or known in the massage art) is adjusted to individual body forms in order to apply a normal force to the body. Sensors 222 that surround or otherwise connected to the end effector 219, measure the distance 220, 221 to the body surface (i.e., the patient's skin). These measurements are used to calculate the desired normal force direction and then the robot end effector axis is oriented in alignment with the same normal force direction. The mechanics and method of sensing simplify the programming requirements for an end effector 219 to follow a path. In a preferred embodiment, still referring to FIG. 13, only X and Y coordinates are programmed and calibrated because the robot then determines the Z coordinates (the Z-axis is the axis normal to the body surface) by measurement, as described above.

In another preferred embodiment, the sensors can be omitted. In this embodiment, in order to determine the normal force direction, the machine is programmed such that the body shape is generalized as a cylinder, half cylinder or other general body shape and the end effector is controlled to apply the force normal to the general body shape.

The normal force or the force applied by the end effector 219 is predetermined, but, in a preferred embodiment can be changed by the user during use. For example, if the initial force is 50 N, the user can command (via voice command, touch screen or other control) to increase or decrease force/pressure. If the user says “harder” the force may increase to, e.g., 75 N or the user says “softer” the force may decrease to, e.g., 25 N. Also, the initial path can be programmed such that the normal force changes during the course of the routine or massage. In an embodiment of the invention, a series elastic motor or actuator can be used to sense and apply the proper or desired force. Therefore, the initial or calibrated path can just be X and Y coordinates and the end effector 219 will move up and down with the contours of the body and will apply a continuous or constant force against the body surface.

With reference to FIG. 13, by way of example, if one were to program the end effector 219 to follow a path along the body surface from point 223 to point 224, only two data points would be required (223 and 224) and only the X/Y coordinates. The robot would then move in a straight line from point 223 to point 224, but follow the contour of the body (Z-axis movement) while maintaining the desired normal force end effector 219 normal orientation to the body. As the robot moves across the contour it measures distance to maintain orientation (and can rotate about any of the joints, as necessary) and measures force torque to know how to move in the Z direction. If the contour is moving downwardly, the robot senses a reduction in force and therefore moves the end effector 219 down in the Z direction to maintain a desired force set point. If the contour is moving up in the Z direction relative to the end effector 219, the robot senses an increase in force and therefore reduces the force applied, all the while rotating as necessary to maintain the axis of the end effector 219 normal to the body surface. It will be appreciated by those of ordinary skill in the art that the end effector 219 behaves like it is mounted to a software defined digital constant force spring. That digital spring maintains a constant force on the body as the end effector moves around within an X/Y based path and routine. The digital spring allows the end effector 219 to follow the Z direction contour of the body form.

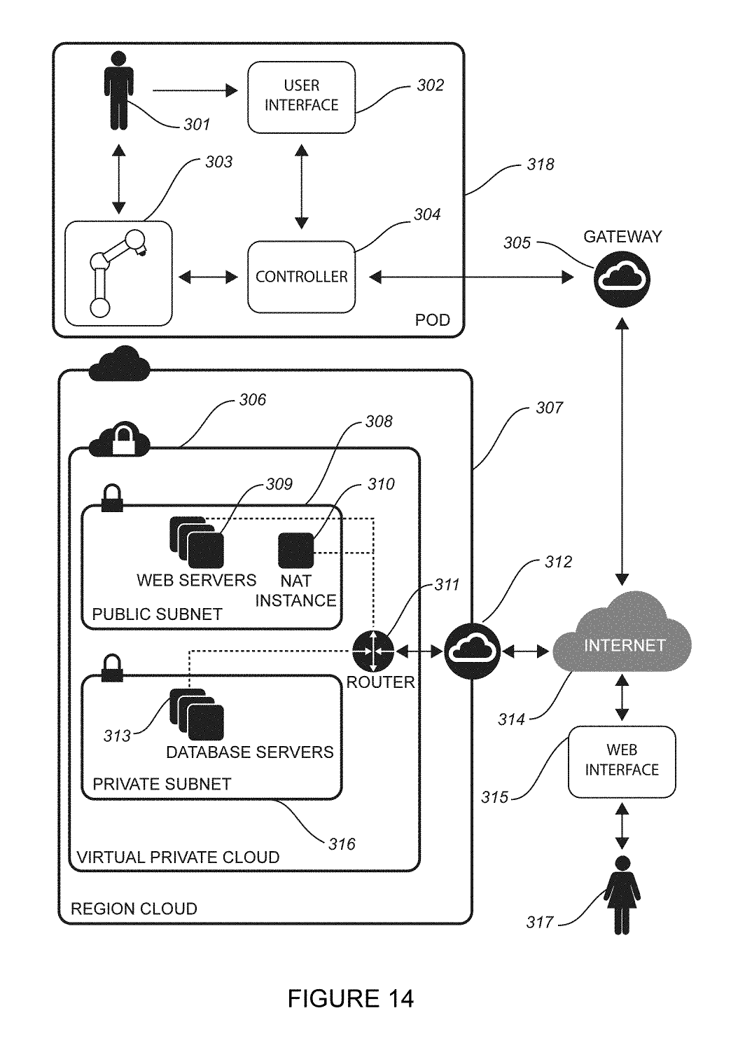

In a preferred embodiment, the calibration Graphic User Interface (GUI) can be accessed via the web interface 315, as shown in FIG. 14, as well as with the manual User Interface 46 as shown in FIG. 5. The mapped pathways are scaled to fit by software programming between anatomical calibration points (see, e.g., the '805 patent). By way of example, if User A designs a path between point 207 and point 209 (see FIG. 11) and that distance (the initial massage path) is measured to be 400 mm on his/her anatomy and that program is loaded by User B that has a measured distance between his/her point 207 and point 209 of 300 mm, the calibrated massage path will be scaled down for the robot to follow. The determination of the anatomical calibration points can be done by a scanning or imaging machine. In another embodiment, the user can lay down on a sheet or canvas that has X/Y coordinates or an X/Y grid thereon to determine their size and these coordinates can be entered into the controller. The machine can then adapt the calibrated pathway to the user's coordinates extrapolated from the coordinates of the original user or the preprogrammed or initial path. For pathways not reaching specific anatomical calibration points, the paths are interpolated to the closest neighboring points. This can be done using standard 3D scanner technology that maps 3D objects into a 3D model and then that model, in this case a human body, can be visualized and utilized for secondary processes because the form is then known in the computer. A simple search for a 3D scanner will show an example. This is not really a claim as much as documentation that we may use this to map the human body. In another embodiment image or sensor based technologies can be used to map the human form for each user. The machine can then be calibrated to allow for pre-programmed end effector paths to be utilized by users of different body forms.

In further detail, referring to FIG. 14, is a network diagram showing the general organization and connectivity of the network. Other embodiments of the network can accommodate an unlimited number of devices, networks and subnets. The diagram shows that the user 301 uses the interface 302 to issue commands to the controller 304 and in turn the controller drives and receives feedback from the robot 303. The controller 304 can be controlled via the interface 302 through touch screen, button, joystick, voice command interface (or a combination thereof). For example, on the touchscreen, the user can use his or her finger to draw the pattern or path on the outline of a human body depicted on the screen. The robot 303 acts on and receives feedback sensing from the user 301. The robot is shown inside a pod 318 enclosure. In other embodiments the robot can be used without a pod 318 enclosure. The controller 304 is connected to the outside network through a gateway 305 and via the internet 314 and through the cloud gateway 312 to a regional cloud 307 and a Virtual Private Cloud 306. Other connectivity scenarios will be understood to those of ordinary skill in the art. Inside the regional cloud 307 is shown a router 311 that directs traffic to public subnet 308 and private subnet 316. Inside the public subnet 308 is shown web servers 309 and a network address translation (NAT) instance 310. The private subnet holds the database servers 313. A remote interface user 317 may access the network through a web interface 315. It will be appreciated that this connectivity provides a method for interfacing remotely to the robotic massage machine. For example, it can be an autonomous program that executes to a specific routine, a technician who resides in another location, etc. The actual robot controller device may be in the cloud and the user can interact from the local salon through the internet to a cloud based robot controller and then the controller commands the robot back through the internet to execute.

In further detail, referring to FIG. 15 is shown an exemplary embodiment of the user interface touch tablet 46. On the tablet 46 are shown general control icons 405 for speed and pressure for the left and right robotic arms 31, 36. Still referring to FIG. 15 are shown the icons 401 and 402 used for identifying time based location of the left and right end effectors on the robotic arms 31,36. In other words, as the robot moves along the path the user can control how fast it is moving based on where the robot is along the path. The robotic arms are controllable in the timeline of the calibrated path for position, force, and speed. Still referring to FIG. 15 is shown a typical menu icon 403 and a moveable icon 404 for setting the time based location of the end effector icons 401, 402. Still referring to FIG. 15 is shown a safe zone 406 to prevent the end effector from being programmed or moving into this area. Essentially, the user can outline areas on the screen over the outline of the on screen body image where they want to prevent the robotic arms from going during a massage routine. Examples could be not massaging directly over the spine bones with a hard roller ball, or not along the edge of shoulder blades or well away from the head area.

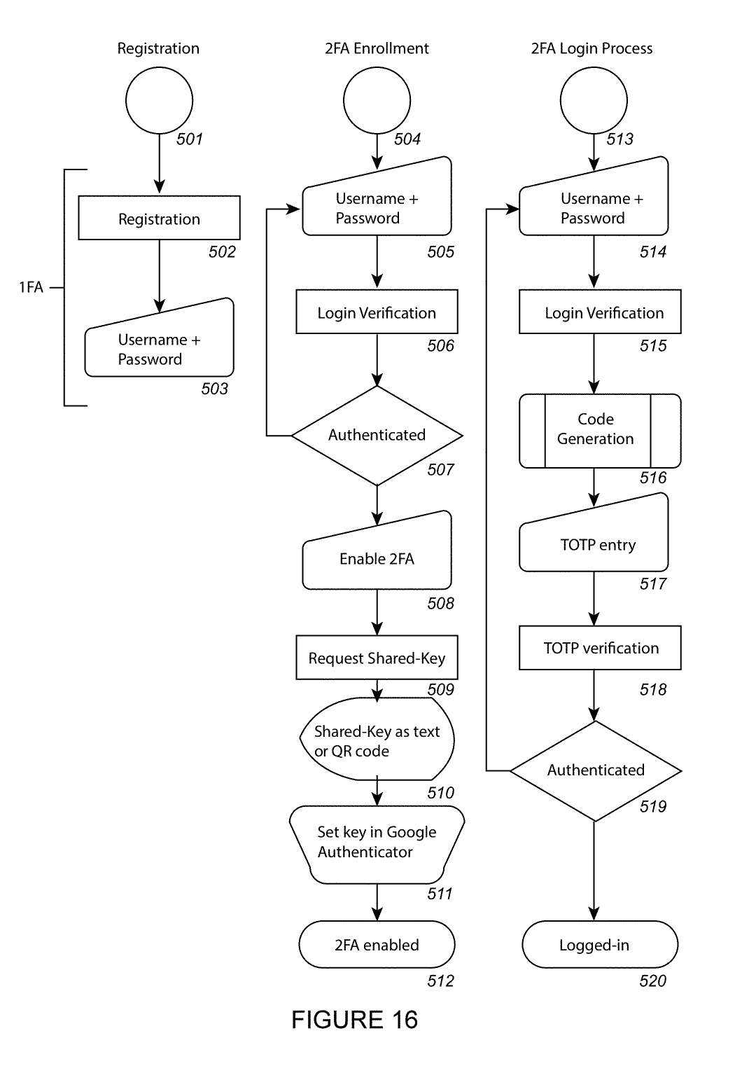

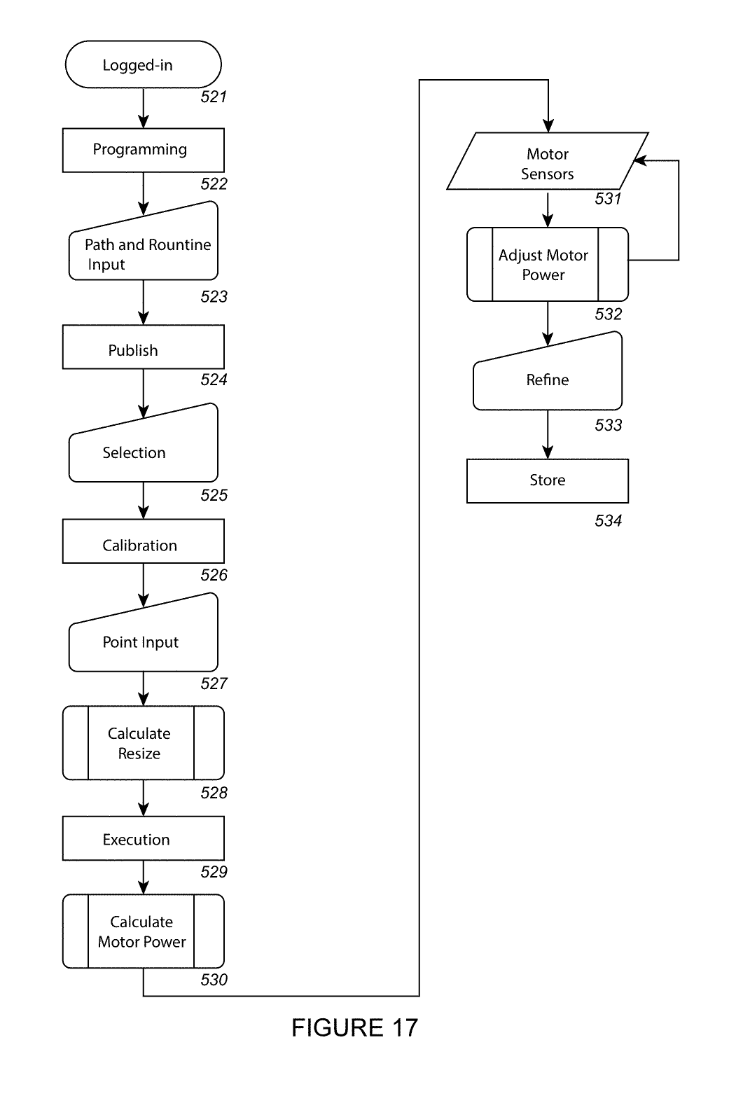

In further detail and to describe an exemplary process for using the invention, FIGS. 16 and 17 describe the general process for registration, access and operation of the invention. In a preferred embodiment, the invention is accessed through an internet connection (or can be a closed circuit or data system). The Internet connection may be established via the local User Interface 46 or via any internet connected device 315. Utilizing an internet connected device a new user must first register into the network of the invention gateway 312. The user shall input first factor authentication (1FA) credentials in steps 501-503 of FIG. 16. Following input of the first factor of credentials the user shall then setup the second factor of authentication (2FA) in steps 504-512. Subsequently, the user may connect into the network by executing steps 513-520.

Once connected into the network as shown in FIG. 17, step 521. From this connection point 521, the user may perform general operations. The order of operations may not be constrained to any particular order for the general user. In other words, if a program has already been entered and calibrated for the user, the user may jump directly to Step 529. For clarity we shall address each step as if a user is starting from first input and not utilizing pre-stored programs on the network. The user then proceeds from Step 522 to program the robotic massage machine 303 to follow a defined routine. The programmed routine can consist of machine path 215, speed, table rotations as shown in FIGS. 5, 6 and 7, end effector 58, 46 selections, force, ambient conditions of light 20, sound 16, temperature 15 and aroma 21 (and changes to any of the above during the defined routine). Programming may be accomplished by “teaching” the robot by a combination of manually pushing the end effector 58 along a path and storing the path and parameters into time steps. One method that can be used for “teaching” is for a technician or other person to manually push the robot arms and end effectors over the top of a user and the robot will record the path and moves that are taught to the robot. Another method is to draw lines in a continuous path over an on screen body image and then the robot will follow that path in accordance with the speed and force input in to the program by the user. During the operation of the routine the user can interrupt the program to make changes, and those changes are stored as an alternate program which can later be recalled and shared. Methods for changing the program may be by a user interface screen, as well as voice commands that are converted into text and then applied as user input. Times steps are referring to the animation timeline. For example a 15 minute routine may have a 50 N force for the first 5 minutes and a 40 N force from minutes 5 to 10. The path can be input as a discrete line path 215, or a path area 217. Inside the path area the end effector 58 will perform a random path at a given force and speed for a specified length of time. The path and area can be graphically drawn with the application user interface over a standard body form as shown in FIGS. 12 and 15. In this scenario, the user first establishes their personal anatomical calibration point by placing the robot at the desired calibration or starting point and teaching the robot the X,Y,Z coordinate for each point on their body (the set of anatomical calibration points, which can be as few as one, from the first user or the initial massage path are referred to herein as a first body form). When a particular routine is then run for that second user's body profile, the routine will be morphed to match that user's anatomical calibration point topology. In a preferred embodiment, even after the routine is running, the user can micro adjust the shape of the path. Preferably, the user can speak to the robot and speak commands, e.g., “a little bit left” or “a little bit right.” It will be appreciated by those of ordinary skill in the art that the influence zone of these commands are adjustable so that when a user asks for position adjustments, it can influence all path points from where the robotic arm is at that instance out to a distance of zero to some radius away. Following path and routine input 523, the program is published 524 into the system or stored in memory (e.g., in the controller 26). In a preferred embodiment, parameters can be set to restrict sharing of the program with self, friends and the public.

Initial programming setup is done by programming the initial path, including force and speed. The program can be stored and reused by the user and/or the program can be shared through a social network share solution. Following initial programming setup, a program that the user has permissions for may be selected 525. The selected program (or pre-programmed/initial path 215) then must be calibrated 526 to the current user or second user body form by inputting anatomical calibration points 527 as shown in FIG. 11 and described previously (the set of anatomical calibration points, which can be as few as one, from the second user are referred to herein as a second body form). The application will then calculate and resize 528 the path (to provide the calibrated path 216) as shown in FIGS. 12a and 12b (the calculation and resizing of the path is referred to herein as morphing). The system is then ready to execute 529 the program. During execution, the robot motors receive power as necessary to follow the calibrated path and force requirements. The controller 304 receives motor feedback and adjusts power as necessary to maintain force as specified in the program. In a preferred embodiment, the feedback is used to stop the robot in the event of an unexpected object in the path. It will be appreciated by those of ordinary skill in the art that the force is limited throughout the operation to be within safe operating limits for collaborative robots. During the execution of the program, the user can interrupt and modify the program as desired. Any modifications are stored so that the modified program can be stored 534 for repeat utilization and sharing.

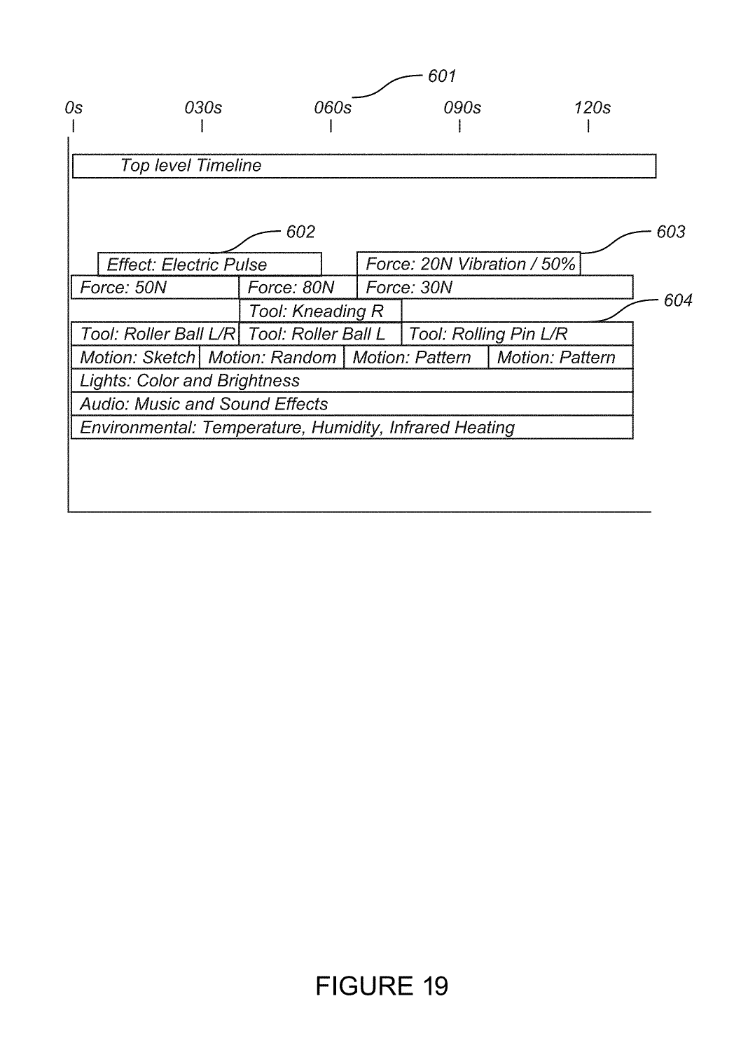

In general, the robot programming and other environmental and audio/visual effects can be understood as an automated sequence of operations over a period of time. In a preferred embodiment, in order to make programming simple and familiar to consumer level users who are not robotic engineers or computer programmers, the user interface is designed in a similar way to that of, e.g., Adobe After Effects, which is an industry-standard tool for video compositing, motion graphics design, and animation for consumer and professional use. In a preferred embodiment, a complete massage routine is developed on a common timeline called a composite sequence and will play out in a similar way to a movie. The final routine may include many sub-routines called compositions as shown in FIG. 19. It will be appreciated that the layout shown in FIG. 19 is only exemplary and the massage routine can be developed in other ways or by other methods.

A composition is the framework for a motion, audio, visual or other therapeutic routines. Each composition has its own timeline. A typical composition includes multiple layers that represent components such as robot path and speed items, force and vibration parameters, environmental conditions, audio and visual effects, Virtual Reality (VR) scenes and lights. Each of these items can be thought of as footage in a massage routine movie. The user adds a footage item to a composition by creating a layer 602 for which the footage item is the source. The user then arranges layers within a composition in space and time, and composite using transparency features to determine which parts of underlying layers play through the layers stacked on top of them. By way of example, if a vibration layer 603 with a 20 N force set point were placed over another force layer set to 30 N and the vibration layer is set to 50% opacity, the resultant maximum force that will be imparted by the robot will be 35 N. Only similar functionalities are affected by transparency. Continuing with the previous example, if an audio layer were placed below the force layers, the audio layer would play through at 100% of its set points regardless of the force layer transparency settings because they are of different functionality. Similarly, an electric pulse effect layer 602 located over a force layer will allow the force layer to play at 100% of its set point value. Likewise, choosing an interchangeable end-effector 604 such as a roller ball, kneading roller or rolling pin for the left (L) and right (R) arms is not affected by transparency.

Simple projects may include only one composition; complex projects may include hundreds of compositions to organize large amounts of automation or many different therapeutic modalities. Each composition has an entry in the Massage Routine panel and each composition type such as path design, or VR has its own context menu to change settings. The location in the timeline and the duration of a sequence or composition is shown graphically as a rectangular labeled bar. The location designates when the sequence or composition will be played and the length of the bar specifies the duration. For example, dragging a bar to be longer for a motion sequence or composition will make the robot motion velocity slower. It is also possible for a motion sequence to specify the motion speed and the length of the bar will be calculated based in the overall length of the path and the specified speed of operation.

When working with a complex routine, it easiest to organize the routine by nesting compositions-putting one or more compositions into another composition. This is particularly helpful in pulling many different compositions from several different massage routines created by other users.

In a preferred embodiment, three path planning methods are provided that make programming a motion composition easy for a consumer who is not a robotic engineer or computer programmer. The three methods are referred to herein as Sketch, Random and Pattern. Using these methods, a user can plan the path the robot will take within the composition timeline.

In Sketch mode, a programming user can use any computer pointing device or their finger on a touch screen to draw a continuous path in a graphic layer above an outline of a human body form 215 (the initial massage path), as shown in FIG. 12a. The robot will follow the path from start point to the end point in accordance with the composition timeline. As described previously, the path will be calibrated 216 (the calibrated massage path) to the end user's profile each time the sequence is executed.

In Random mode the user draws out a closed loop area in a graphic layer above an outline of a human body form 217, as shown in FIG. 12b. The robot will operate within the specified boundary in a similar way as an iRobot Roomba vacuum randomly moves within a room boundary as described within U.S. Pat. No. 6,809,490. As described previously, the boundary will be calibrated to the end user's profile.

In Pattern mode, the user can choose predefined patterns such as a spiral, a figure-8 and other geometric patterns. Each pattern has a start point and an end point that the robot will follow in accordance with the composition timeline. It will be appreciated that the patterns are the initial massage routine. Patterns can be scaled and rotated in the graphic user interface and placed in a layer above an outline of a human body form.

When developing a project, an unlimited number of Sketch, Random and Pattern compositions can be nested and layered into the top level project timeline. See, e.g., FIG. 19. By way of example, one Sketch mode motion composition could take place for the first 68 seconds of the timeline, followed by 600 seconds of Random mode operation within a boundary area and finally 60 cycles of a figure-8 Pattern where each figure-8 motion composition has its own 3 second timeline making the total top level figure-8 operation 180 seconds on the timeline. Additionally, an unlimited number of other automation effects such as a VR scene, environmental conditions and lighting effects can be composited into the project.

Compositions and sequences can be nested together and all other items can be combined within the layer framework of the composition and sequence architecture. Pulling from shared libraries, compositions, sequences and items can be dragged and dropped into new a composition time line and layered to meet operation objectives. Each item is shown in the time line as a bar 602, 603, 604. Item bars can be sub-divided to allow for changing parameters. Bars can be edited using similar methods used in industry standard non-linear video and animation platforms. Each item contains a context menu of parameters such as force, speed, amplitude and other control parameters.

Social sharing of massage routines can be shared at all levels within the routine development framework. Any system user who develops a full routine or any item within a routine may share the full routine or any item within the routine. Items may include a composition as that is understood from the discussion above. For example, the following describes a composition that includes two motion item sequences. The first consisting of a Random mode path plan designed to play out in the timeline in the lower back region as displayed within the graphic user interface showing the outline of a human body form. Additional composition parameters are set in this example to modify this Random path operation with a 40 N force and a speed of 500 mm/s. The second motion item sequence consisting of a Pattern mode path plan with a Figure-8 geometry and designed to play out in the upper back region with a 35 N force at 200 mm/s. Additionally, in this example the same composition contains an item sequence for raising, dimming and adjusting the brightness and color hue of the lighting within the privacy pod during the routine time line. Sharing may occur at any level within the previous example. The routine may be shared as a whole allowing the end user to simply run that routine directly. For items that include a location component, the end user's calibration data set will be used to adjust the items morphology or location to match the geometry saved in the end user's profile. Any item within the routine such as a composition, motion sequence, lighting sequence, VR sequence, YouTube or other video and audio internet link sequence, Pattern geometry, Sketch path, Random path area, end-effector tool, lighting device, heating device and any other items that may be developed by system users.

System users can access public and private shared libraries of routines, compositions, sequences and items and combine them in any desired order to develop custom routines, compositions, sequences and items.

During routine execution, users can interact by voice and touch control to modify the routine parameters. For example, a user can issue a command to change a force parameter. Any changes to parameters made during routine execution can be saved to make a custom routine, composition, sequence or item. In the case of saving as a routine, the user can later play that routine that includes all modification made during the previous execution.

The construction details of the invention as shown in FIG. 1 for the robot 10 may be metal and other sufficiently rigid strong materials such as high strength plastic, or composite reinforced plastic to support heavy loading by user weight. Other materials such as foam, gel and textiles shall be used to create ergonomic functionality and comfort for user anatomy. Referring further to FIG. 1 the construction details for the pod 11 may be wood or of any other sufficiently rigid and strong material such as high-strength plastic, metal, and the like. Insulation materials may be used inside wall cavities to provide control of temperature and sound penetration through the walls. The floor, walls and ceiling are typically constructed of modular elements that form a self-standing enclosure.

The following are some of the features and methods of the present invention, without limitation: dual 6-axis collaborative robotic arms 31, 36 used for the purpose of human massage. In another embodiment, the arms can have fewer than 6-axis movement. Robotic arms 31, 36 controlled to apply a user defined force normal to the body surface. Robotic arms 31, 36 controlled to avoid safe zones such as the human head area, spine center line, or other areas. A massage table adjustable to accommodate tall users without needing longer robotic arms 31, 36, which can translate or moved horizontally (as shown in FIG. 8). Robotic arms 31, 36 controlled to apply a massage routine while the massage table pads or modules are rotating or pivoting through their respective degrees of freedom (as shown in FIGS. 4, 5, 6 and 8). A robotic massage machine that transforms into a transportable system capable of fitting through standard doorways. A robotic massage machine that rotates into a generally vertical form in order to aide users to mount the machine from a standing posture (as shown in FIG. 10). For example, if the step is rotated horizontally (from what is shown in FIG. 10) a user can step on the step and lean against the table. Then the table can be lowered down to a horizontal position (e.g., by motor(s), hydraulics or air). Machine programming based on memorizing body surface contact points. Machine programming based on drawing lines on a computer screen over a body figure outline. Calibration of the massage machine to allow programmed routines to be used between different body forms. Machine programming to control the robotic arms 31, 36 to perform a massage routine for a specified time, applying a specified force, but following a random path within a bounded area 217. Automatic change of end effector 58 in accordance with a specified massage routine. The ability to perform physical therapy tasks such as applying resistive force, traction or range of motion testing. For example, a physical therapist may pull on head, arms and legs to apply traction for various therapeutic reasons. The robotic massage machine can be programmed to do the same. The robot can measure the range of motion very precisely by asking the user to push the robot arm as far as possible and then recording the robots joint position and back calculating the resultant range of motion. This data can then be stored in the users profile and compared to future measurements. All tasks can be measured, recorded and then used for performance, and improvement analysis. Social network sharing environment for programmed routines. Remote programming, control and monitoring of the massage machine by medical professionals and other authorized users. Complete ambient environment control of temperature, light, humidity, sound and smells (as shown in FIG. 2).

In a preferred embodiment, the present invention includes, without limitation, the following. The ability for people who are not robotic engineers (or who are) to program and utilize multi-axis robotic arm(s) and integrated robotic tables for the purpose of massage and physical therapy. Simplified programming through the use of a software defined digital spring to move the robot normal to the X/Y plane. Simplified path and force programming by using sensors to maintain end effector orientation normal to the body form or subject while moving along a contoured path. The ease of touch screen or voice control of path, speed and pressure applied by the robot.

In a preferred embodiment, the present invention also includes, without limitation, the following. Social network sharing to enable rapid and diverse therapy programming. Improved pain relief and overall effectivity through the precise control of end effector motion and force output utilizing a number of degrees of freedom. The ability for medical professionals to design robotic massage and physical therapy routines at their respective offices without owning a robotic massage machine and then securely sharing these routines over the internet with their patients who can retrieve their prescribed therapy routine at their location or a participating robotic massage therapy facility. Improvement in effectivity of robotic massage for chronic pain relief by variability of therapy through participation in a social network sharing program to access an unlimited number of custom routines developed by medical professionals and other end users. An online networking design that enables end users to access shared or saved routines from any location with a participating robotic massage machine.

The ability to create therapy routines that also control ambient temperature, spot body temperature with infrared technology, VR, light control, music, sounds and aromas in a self-contained massage pod or room, which improves the overall therapy beyond just the mechanical manipulation by end effectors.

In a preferred embodiment, the present invention also includes, without limitation, the following. Rolling wheels and hinged appendages that allow the device to be portable within facilities and fit through common doorways. In broad embodiment, the invention is a method for creating an unlimited variety of robotic massage therapy routines and sharing routines between an unlimited numbers of users to control an environment and multi axis massage machine.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further any specific numbers noted herein are only examples: alternative implementations may employ differing values or ranges.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

While certain aspects of the disclosure are presented below in certain claim forms, the inventors contemplate the various aspects of the disclosure in any number of claim forms. For example, aspects of the disclosure may be embodied as a means-plus-function claim under 35 U.S.C. §112, ¶6, or in other forms, such as being embodied in a computer-readable medium. (Any claims intended to be treated under 35 U.S.C. §112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A robotic massage machine comprising:
at least one movable robotic arm having a first end effector,
a processor, wherein the processor controls the movable robotic arm,
a memory,
a first body form having at least a first anatomical calibration point,
a preprogrammed initial massage path based on the first body form, and
a second body form having at least a first anatomical calibration point located in an analogous anatomical location as the first anatomical calibration point of the first body form,
wherein the processor is programmed to morph the initial massage path to calculate a calibrated massage path based on the second body form.

2. The robotic massage machine of claim 1 wherein the processor is programmed to move the robotic arm such that the end effector follows the calibrated massage path.

3. The robotic massage machine of claim 1 wherein the processor is programmed to move the robotic arm such that the end effector moves within an area bounded by the calibrated massage path.

4. The robotic massage machine of claim 1 wherein the processor is programmed to maintain the end effector at an orientation that is generally normal to the subject.

5. The robotic massage machine of claim 4 wherein the processor is programmed to cause the robotic arm to press the end effector against the subject at a generally constant pressure.

6. The robotic massage machine of claim 5 wherein the robotic arm includes a sensor that senses the pressure applied to the subject.

7. The robotic massage machine of claim 5 wherein the robotic arm includes a series elastic motor.

8. The robotic massage machine of claim 1 wherein the first body form includes a plurality of anatomical calibration points and wherein the second body form includes a plurality of analogous anatomical calibration points.

9. The robotic massage machine of claim 1 wherein the robotic massage machine includes a plurality of movable robotic arms that are controlled by the processor.

10. The robotic massage machine of claim 1 further comprising a table, wherein the table includes at least one module that is pivotable about an axis.

11. A method of controlling a robotic massage machine having a processor, a memory, and at least one movable robotic arm, the method comprising the steps of:
a) providing a preprogrammed initial massage path on a first body form, and
b) morphing the initial massage path on a second body form to calculate a calibrated massage path.

12. The method of claim 11 wherein the first body form has at least a first anatomical calibration point, and the second body form has at least a first anatomical calibration point located in an analogous anatomical location to the first anatomical calibration point of the first body form.

13. The method of claim 12 further comprising the steps of determining the first anatomical calibration point of the second body form, and inputting the data associated with the first anatomical calibration point of the second body form.

14. The method of claim 11 further comprising moving the robotic arm such that the end effector follows the calibrated massage path.

15. The method of claim 11 further comprising moving the robotic arm such that the end effector moves within an area bounded by the calibrated massage path.

16. The method of claim 1 wherein the processor is programmed to maintain the end effector at an orientation that is generally normal to the subject when the robotic arm is moved.

17. The method of claim 16 wherein the processor is programmed to cause the robotic arm to press the end effector against the subject at a generally constant pressure when the robotic arm is moved.

18. The method of claim 17 wherein the robotic arm includes a sensor that senses the pressure applied to the subject.

19. The method of claim 17 wherein the robotic arm includes a series elastic motor.
